(19) United States
(12) Patent Application Publication
(10) Pub. No.: US 2007/0294716 A1
(43) Pub. Date: Dec. 20, 2007

(54) Method, medium, and apparatus detecting real time event in sports video

(75) Inventors: Jin Guk Jeong, Yongin-si (KR); Eui Hyeon Hwang, Goyang-si (KR); Ji Yeun Kim, Seoul (KR); Young Su Moon, Seoul (KR); Sang Kyun Kim, Yongin-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-si (KR)

(21) Appl. No.: 11/589,910

(22) Filed: Oct. 31, 2006

(30) Foreign Application Priority Data
Jun. 15, 2006 (KR) 10-2006-0053882

(51) Int. Cl. H04H 9/00; H04N 7/16

(52) U.S. Cl. 725/19; 725/9; 725/18

(57) ABSTRACT

A method, medium, and apparatus detecting a real time event in a sports video. The method may include testing a confidence of an online model, calculated in a sports video stream, detecting an event by using an offline model in the sports video stream, when the confidence of the online model does not meet a threshold, training the online model through an event detected by using the offline model, and detecting an event by using the online model in the sports video stream, when the confidence of the online model meets the threshold.

### CROSS-REFERENCE TO RELATED APPLICATIONS

This application claims the benefit of Korean Patent Application No. 10-2006-0053882, filed on Jun. 15, 2006, in the Korean Intellectual Property Office, the disclosure of which is incorporated herein by reference.

### BACKGROUND OF THE INVENTION

1. Field of the Invention

An embodiment of the present invention relates to a method, medium, and apparatus detecting a real time event of a sports video, and more particularly, to a method, medium, and apparatus detecting a real time event in a sports video by combining the implementation of an offline model and an online model.

2. Description of the Related Art

Generally, techniques for detecting real time events in sports videos have been used in digital televisions (DTVs) or personal video recorders (PVRs), especially in DTVs and PVRs that include time shift capabilities. Such time shift capabilities enable users to pause real-time broadcast television, or to watch a previously broadcasted program at a time that is more convenient. Particularly, time shifting may be effectively used in sports broadcasts where a live broadcast is considered important. Accordingly, techniques for detecting an important event in real time in a sports video are desired so users can watch previously broadcasted programs more effectively.

In addition, even when such time shift capabilities are not available, such PVRs may include a summary capability to enable users to easily use a navigation system by providing summary information, including important events with respect to a prerecorded television broadcast. Accordingly, for example, when a broadcast is retransmitted between a DTV and a mobile terminal, techniques for detecting events are desired for potentially retransmitting only streamed video regarding the important events, rather than all available video streams.

Conventionally, the detecting of events has been accomplished using templates, offline training models, and online training models. Here, the reference to online and offline training models refers to models that operate real-time with received video data and models that operate after receipt of the video data, respectively. Such real-time operation may further include dynamic changes to the model while operating in real-time.

First, as an example, one conventional technique of detecting an event uses a template, as discussed in U.S. Patent Publication No. 2003/0034996, entitled “Summarization of baseball content”. Here, baseball videos are analyzed by using a simple template, e.g., through a green mask and/or brown mask, in a baseball game video, and detecting a starting point of a play within the baseball game based on a ratio of brown and green colors. In one example, an ending point of the baseball game may be detected by a shot where a baseball field of the baseball game is not shown. Based upon these start/stop play times the baseball game video is summarized. However, as shown in FIG. 1, the color of the baseball field may vary, e.g., due to place, time, weather, or lighting. Accordingly, such a conventional technique of detecting an event based on a template may not accurately detect a play starting point or ending point in a baseball game. Similarly, such a conventional technique for detecting events based on a template may not accurately analyze events based on such single templates.

Second, as another example, a conventional technique for detecting events based on an offline training model was proposed in “Structure analysis of sports video using domain models” in the International Conference on Multimedia and Expo (ICME) 2001. Here, an offline model was generated by using learning techniques and color information, candidate frames were detected by using the generated offline model, and a shot analyzed based on object segmentation/edge information. Here, a shot can be representative of a series of temporally related frames for a particular play or frames that have a common feature or substantive topic. Another technique for detecting events based on such an offline training model has been proposed in the paper “Extract highlights from baseball game video with hidden Markov models”, in the Institute of Electrical and Electronics Engineers (IEEE) International Conference on Information Processing (ICIP) 2002. Here, types of baseball shots, e.g., strike-outs, home runs, or some apparent exciting series of frames, are segmented based upon a Bayesian rule, a field descriptor, edge descriptor, an amount of grass shown, sand amount, camera motion, and player height. Variations for each of the baseball shot types are learned by using hidden Markov models (HMM), and used for detecting an event, e.g., such as one of these apparent ‘exciting’ occurrences.

As another conventional offline training model example, another technique for detecting an event is discussed in U.S. Patent Publication No. 2004/0130567, entitled “Method and system for extracting sports highlights from audio signals.” Here, audio data is classified into six classes including applause, shout of joy, sound, music, and sound mixed with music. Classes having a period longer than a predetermined period, among classes classified as the applause or the shout of joy, are included in highlights. Then, the classes having a longer period are classified based on previously learned models. However, this conventional technique for detecting an event by using an offline training model may not reflect various features of sports videos, including feature changes within the same game, and may not accurately analyze events by using a single type of offline training model.

Last, as an example, a conventional technique detecting an event based on an online training model has been proposed in “Online play segmentation for broadcast American football TV programs”, in the Pacific Rim Conference (PCM) 2004. Here, a play period of an American football video was detected by using a ratio of the color green and a number of detected lines. The play period was adaptively applied for each game by using a color of a football field as a dominant color of all streams, and the relative green color was dynamically adjusted during receipt of the video data. In this online training model technique of detecting events an online model was individually generated for each game. However, this technique may not accurately detect events in real time, since the complete online model is generated only after analyzing the entire video.

### SUMMARY OF THE INVENTION

An aspect of an embodiment of the present invention provides a method, medium, and apparatus detecting a real time event in a sports video.

Another aspect of an embodiment the present invention also provides a method, medium, and apparatus accurately detecting an important event in real time in a sports video.

In addition, still another aspect of an embodiment of the present invention provides a method, medium, and apparatus accurately and rapidly detecting real time events in a sports video by selectively using an offline training model prior to generating an online training model.

Additional aspects and/or advantages of the invention will be set forth in part in the description which follows and, in part, will be apparent from the description, or may be learned by practice of the invention.

To achieve at least the above and/or other aspects and advantages, embodiments of the present invention include a method of detecting an event, including determining a confidence value of an online model for detecting an event in an input data stream, detecting an event by using an offline model for detecting the event in the input data stream when the confidence value of the online model is lower than a threshold, and detecting the event by using an online model for the input data stream when the confidence value of the online model is higher than the threshold.

Here, the input data stream may be a sports video stream.

In addition, the method may include training the online model through the detected event such that a confidence level of the online model is increased for the detected event at least when the detected event is detected by the offline model.

Further, the training of the online model may include training the online model through the detected event when the detected event detected by the offline model satisfies a standard for the online model.

The method may further comprise updating the online model after detecting the event by using the online model.

Still further, the training of the online model may include segmenting video data of the detected event into frames according to minimum units when the detected event detected by the offline model is the video data, selectively assigning and generating clusters for the online model by analyzing the minimum units, and selecting a cluster for generating a to be implemented model, from the selectively assigned and generated clusters, and generating the online model with at least the selected cluster.

The selectively assigning and the generating includes calculating a difference value between at least one preexisting cluster and a newly calculated cluster based upon the detected event, assigning data of the newly calculated cluster to the at least one preexisting cluster when the difference value meets a difference threshold, and generating at least one new cluster for the data of the newly calculated cluster at least when the difference value does not meet the difference threshold or no preexisting cluster exists.

Further, the training may include calculating an audio energy value of an audio frame, when the detected event detected by the offline model is the audio frame, calculating an average energy by using a preexisting calculated audio energy value and the calculated audio energy value for the detected event, and extracting a corresponding recording level, and updating the online model with the extracted recording level.

The method may further include training the online model through the detected event such that a confidence level of the online model is increased for the detected event at least when the detected event is detected by the online model.

To achieve at least the above and/or other aspects and advantages, embodiments of the present invention include at least one medium including computer readable code to control at least one processing element to implement embodiments of the present invention.

To achieve at least the above and/or other aspects and advantages, embodiments of the present invention include an apparatus for detecting a real time event including a confidence calculation unit to calculate a confidence value of an online model, a first event detection unit to detect an event using an offline model when the confidence value of the online model does not meet a threshold, a second event detection unit to detect the event using the online model when the confidence value of the trained online model meets the threshold.

The confidence calculation unit may calculate the confidence value of the online model in a sports video stream, compare the calculated confidence of the online model and the threshold, and determine a corresponding confidence level of the online model.

In addition, the apparatus may further include an online model training unit to train the online model through the detected event such that a confidence level of the online model is increased for the detected event at least when the detected event is detected by the offline model.

The online model training unit, when the detected event detected by the offline model is video data, may segment the video data of the detected event into frames according to a minimum unit, selectively assign and generate clusters for the online model by analyzing the segmented frames, select a cluster for generating a to be implemented model from the selectively assigned and generated clusters, and generate the online model with at least the selected cluster.

Further, the online model training unit, when the detected event detected by the offline model is an audio frame, may calculate an audio energy value of the audio frame, calculate an average energy of a preexisting calculated audio energy value and a currently calculated audio energy value for the detected event, extract a corresponding recording level, and update the online model with the extracted recording level.

Still further, the apparatus may further include an online model training unit to train the online model through the detected event such that a confidence level of the online model is increased for the detected event at least when the detected event is detected by the online model.

### BRIEF DESCRIPTION OF THE DRAWINGS

These and/or other aspects, features, and advantages of the present invention will become apparent and more readily appreciated from the following detailed description, taken in conjunction with the accompanying drawings of which:

FIG. 1 illustrates differing colors of baseball fields that can weaken conventional event detection techniques;

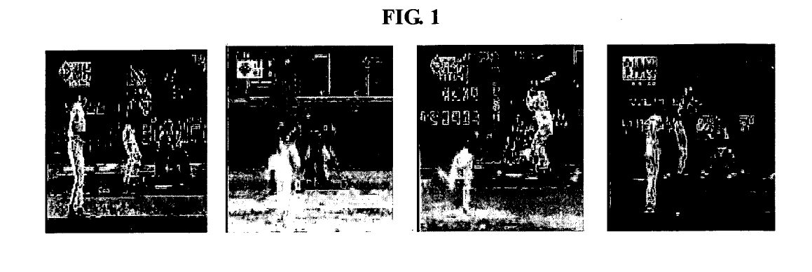

FIG. 2 illustrates a method of detecting a real time event in sports video data, according to an embodiment of the present invention;

FIG. 3 illustrates an online model training method with respect to video data, according to an embodiment of the present invention;

FIG. 4 illustrates an online model training method with respect to audio data, according to an embodiment of the present invention;

FIG. 5 illustrates a method of detecting an important event in baseball video data, according to an embodiment of the present invention;

FIG. 6 illustrates features of a game period of an important event in baseball video data, according to an embodiment of the present invention; and

FIG. 7 illustrates an apparatus detecting a real time event in sports video data, according to an embodiment of the present invention.

### DETAILED DESCRIPTION OF THE PREFERRED EMBODIMENTS

Reference will now be made in detail to embodiments of the present invention, examples of which are illustrated in the accompanying drawings, wherein like reference numerals refer to the like elements throughout. Embodiments are described below in order to explain the present invention by referring to the figures.

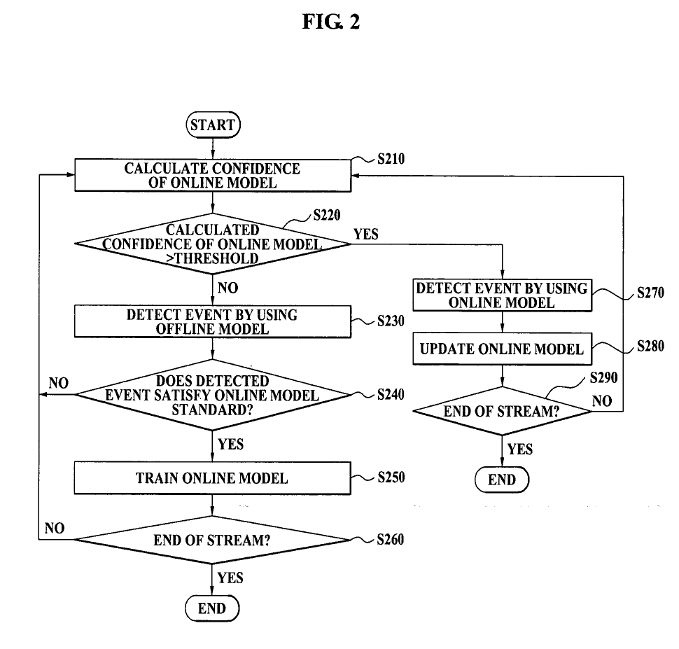

FIG. 2 illustrates a method of detecting a real time event in sports video data, according to an embodiment of the present invention.

Referring to FIG. 2, in operation S210, a confidence for an online model is calculated for a current sports video stream.

As an example, when the online model is a key frame model of a pitching scene, to detect the pitching scene in a baseball game, the confidence of the online model may be determined by a number of data, such as candidate frames, in identified clusters within the online model. Here, clustering is a technique of grouping similar or related items or points based on that similarity, i.e., the online model may have several clusters for differing respective potential events. One cluster may include separate data items representative of separate respective frames that have attributes that could categorize the corresponding frame with one of several different potential events, such as a pitching scene or a home-run scene, for example. A second cluster could include separate data items representative of separate respective frames for an event other than the first cluster. Potentially, depending on the clustering methodology, some data items representative of separate respective frames, for example, could even be classified into separate clusters if the data is representative of the corresponding events. In addition, here, the use of “key frame” is a reference to an image frame or merged data from multiple frames that may be extracted from a video sequence to generally express the content of a unit segment, i.e., a frame capable of best reflecting the substance within that unit segment/shot, and potentially, in some examples, may be a first scene of the corresponding play encompassed by the unit segment, such as a pitching scene. Accordingly, with this in mind, the data in at least one cluster includes data which is representative of at least one aspect of the pitching scene in the key frame model of the pitching scene. In addition, as the number of data in each cluster of the online model increases the confidence of the online model with respect to the key frame model of the pitching scene may increase.

As another example, when the online model is a color model of a baseball ground, to detect a close-up scene in the baseball game, the confidence of the online model may be determined by the data density within the cluster(s) for the online model. Accordingly, here, as the data density for the online model is high, the confidence of the online model with respect to the color model of the baseball ground may be high.

As another example, when the online model is an audio model of an announcer's tone of voice, the confidence of the online model may be based upon the use of time spent for processing a sports video stream, i.e., as longer shots or play may signify an event. Here, as the time spent for processing the sports video stream, in the audio model of the announcer's tone of voice, is long, the confidence of the online model with respect to the audio model of the announcer's tone of voice may be high.

In operation S220, it may be determined whether the calculated confidence of the online model is greater than a threshold. The threshold may be a reference value for determining the confidence of an online model for accurately detecting an event by using only the online model, i.e., without using the offline model. Thus, according to one embodiment, if the calculated confidence level is sufficiently high, only the online model may be implemented.

In operation S230, when the confidence of the online model is not greater than the threshold, events that occur in the sports video stream may be detected by using an offline model.

Here, as an example, when the offline model used is a key frame model of the pitching scene in a baseball game, an event may be detected by using an edge distribution detection methodology, and events of the pitching scene may be detected in the baseball game video stream by using a support vector machine (SVM).

As another example, when the offline model used is a color model of the ground in a baseball game, an event may be detected by using a distribution of a Hue Saturation Brightness (HSB) color. As another example, colors of the baseball ground in the baseball game video stream may be detected by using Bayes rule.

As still another example, when the offline model used is an audio model of an announcer's tone of voice, an event may be detected in the baseball game video stream based on a SVM with respect to the audio model of the announcer's tone of voice.

As described above, in one embodiment, when a recording of a sports video starts, the online model may not be used until the confidence of the online model reaches a reliable level, e.g., after using an offline model for event detection.

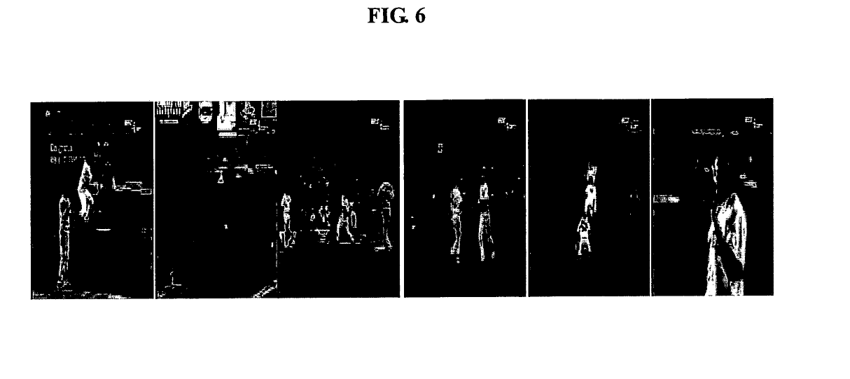

For example, when the sports video is a baseball game video, the sports video may include scenes of home runs and strikeouts. As shown in FIG. 6, features of important events/plays in baseball games may be identified by the fact that the event/play period is typically longer than other scenes, event/plays start with pitching scenes, and that events/plays typically end with close-up views. Similarly, an audio feature of an important event in a baseball game is that the announcer's tone of voice is typically high. Accordingly, when the sports video is a baseball game video, the detecting of an event may detect a pitching scene, a close-up scene or an announcer's tone of voice in the sports video stream to detect the event/play by using the offline model.

In operation S240, whether the detected event satisfies a standard for generating the online model may then be determined. Specifically, in operation S240, whether the detected event data is desired for generating the respective online model is tested.

As an example, when the online model is a key frame model of the pitching frame, it may be determined whether the online model classifies or should classify the same frame or data also as a pitching scene.

As another example, when the online model is a color model of the baseball ground, the pitching frame always includes the ground in the baseball game. Accordingly, it can be determined whether the online model classifies or should classify the same frame or data also as a pitching scene, e.g., based on such expected pitching scene features.

As another example, when the online model is an audio model of an announcer's tone of voice, it can be determined whether the online model classified or should classify the same frame or data also as a base ball scene.

In operation S250, when the detected event satisfies the online model standard, e.g., sufficient pitching scene features are identified and the event should be classified as an event by the online model, the online model may be trained by using the offline detected event. Here, with this addition of more data to the corresponding cluster(s) of the online model the confidence of the online model may be increased. An online model training method will be described in greater detail below.

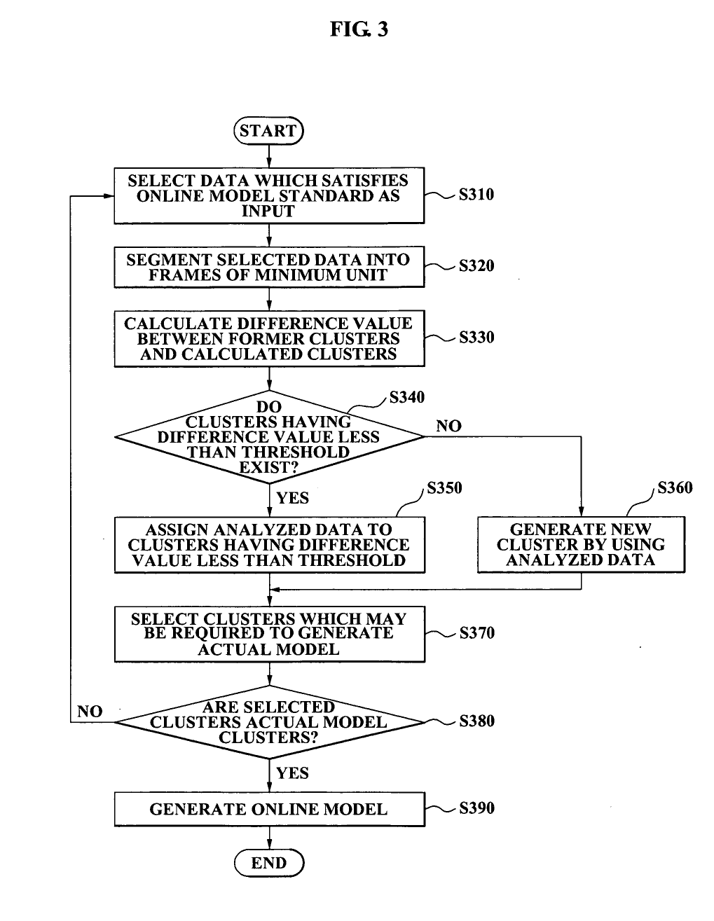

FIG. 3 illustrates an online model training method with respect to a video stream, according to an embodiment of the present invention.

Referring to FIG. 3, in operation S310, data which satisfies the online model standard is selected for input to a corresponding cluster, as the currently detected event data is included in the video data.

In operation S320, the selected data may then be segmented into frames of minimum units. Specifically, for example, when a unit for the online model is the frame unit, an entire frame may be segmented as a single unit. When the unit of the online model is calculated by using pixels, the entire frame may be segmented according to pixel units. Specifically, when the unit of the online model is the frame, the entire frame is designated as the single unit. Similarly, when the unit of the online model is the pixel, single pixels are designated as the single unit.

In operation S330, based on the existence of previous calculated/identified clusters, e.g., of such single units, the segmented data may be analyzed, and difference values between former calculated cluster data and the newly calculated/identified cluster data can be calculated. As only one example, difference values between projections based upon former calculated cluster data and the calculated cluster data can be calculated. Color information may further be used when calculating the difference value. Although colors of a baseball ground may be different for each game, a color of the baseball ground is typically the same in each single game. Accordingly, a Hue, Saturation, and Value (HSV) histogram average value and a distance between each cluster may also be calculated. Accordingly, as another example, a difference value between each of the clusters may be calculated by using a Euclidean distance of the corresponding HSV histograms, here the reference to new clusters may actually be data that will ultimately be added to the original cluster data but it may initially be considered as a separate cluster.

In operation S340, it can be determined whether the calculated difference value is less than a threshold. Specifically, the difference between the former clusters and the calculated clusters may be calculated, and based on the calculated difference it can determined whether the currently calculated/identified clusters should be assigned to the original cluster, i.e., for further learning by the online model.

In operation S350, thus, based upon the calculated difference value being less than the threshold, the analyzed data may be assigned to corresponding clusters found to have difference values less than the threshold. Specifically, when the analyzed data corresponds to standard requirements for the online model, e.g., of a pitching scene, the analyzed data may be added to the corresponding clusters. Thus, according to an embodiment of the present invention, if the difference value for analyzed data is sufficiently low for more than one cluster, the data may be added to more than one cluster.

In operation S360, when there are no clusters within a distance (difference value) less than the threshold, a new cluster(s) may be generated by using the analyzed data. Specifically, when the analyzed data is substantially different from the previously analyzed data, and there is no exciting data similar to the analyzed data, the new cluster(s) may be generated with the analyzed data.

In operation S370, the available clusters that may actually be used with the implemented model may be selected from among the clusters. Specifically, for example, clusters that include the most data may be selected for use in the implemented model.

In operation S380, it may be determined whether the selected clusters will be used with the implemented model. In one embodiment, the standard for determining whether the selected clusters will be used with the implemented model may be changed. As an example, when the implemented model is the color model of the baseball ground, clusters regarding the greatest range of the color of the baseball ground may be used. As another example, when the implemented model is a pitching scene, clusters regarding whether frames are repeated within a short time may be used.

As an example, when the online model is a key frame model of the pitching scene, and the aforementioned number of data included in the selected clusters is greater than the corresponding threshold, clusters of the key frame model of the pitching scene may be determined to exist.

As another example, when the online model is a color model of the baseball ground, and a time spent for processing streams is greater than a predetermined threshold, clusters of the color model of the baseball ground may be determined to exist.

In operation S390, when the selected clusters are determined to be used as the implemented model clusters, the online model may be implemented/generated by using the data included in the selected clusters. The data included in the clusters is generally homogeneous. Accordingly, the online model may be generated by using a representative value, an average value, or a median value of a feature, for example. In this instance, the feature may be extracted from the data.

As an example, when the online model is a key frame model of the pitching scene, the online model may be generated by using an edge distribution that is used in clustering, and an average value of the HSV histogram.

As another example, when the online model is a color model of the baseball ground, the online model may be generated by using the average value of the HSV histogram in clusters of the color model of the baseball ground.

As described above, a method of detecting an event, according to an embodiment of the present invention, may generate a more suitable online model by analyzing data to detect an event associated with the video.

Further, as described above, when adding data, a clustering with respect to the data may be performed. Accordingly, embodiments may include generating a clustering-based model which can be used in real time processing.

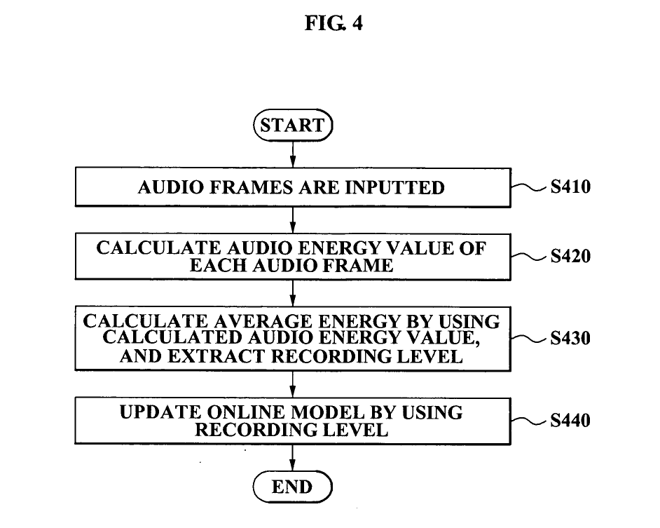

FIG. 4 illustrates an online model training method with respect to audio data, according to an embodiment of the present invention.

Referring to FIG. 4, in operation S410, audio frames of the sports video may be input.

In operation S420, an audio energy value of each of the audio frames may be calculated with respect to audio data.

In operation S430, an average energy may be calculated by using a formerly calculated audio energy value and the currently calculated audio energy value. Also, a recording level may be extracted by using the average energy.

In operation S440, it may be determined whether recorded sound is generally loud or quiet, according to the extracted recording level, and the online model may be updated by using the ascertained information. Specifically, a silent model reflecting the average energy may be reflected, and an audio model of an announcer's tone of voice may be changed. Accordingly, as an example, when the audio model of the announcer's tone of voice is determined to meet the silent model, an event regarding the announcer's tone of voice may be determined to not have occurred.

With regard to FIG. 2 again, when the detected event does not satisfy an online model standard, operation S210 may be performed again.

In operation S260, it may be determined whether a current stream is indicated as being the end of the sports video stream in order to determine whether the operations of detecting the event and the operations of the online model training have been performed.

When the current stream is not the end of the sports video stream, operations from operation S210 may be performed again.

When the calculated confidence of the online model is greater than the aforementioned threshold, events in the sports video stream may be detected by using the online model. Specifically, in one embodiment, when the calculated confidence of the online model is greater than the threshold, the further update and further generation of the online model may only be performed through the operations of the online model training, as the offline model operations may not be necessary. Accordingly, since the confidence is high, events that occur in the sports video stream may be detected by using only the online model, for example. In this instance, a difference value may be calculated between the online model and the sports video stream by using an edge distribution and a weighted Euclidean distance of the HSV histogram, for example.

As another example, when the online model is a color model of the baseball ground, it may be determined that the online model meets the model's baseball ground pixels when each pixel in a frame is similar to the color model of the baseball ground. Similarly, it may be determined that the close-up scene has occurred when a ratio of the expected baseball ground pixels in a single key frame is small, as the close-up scene includes a great ratio of colors associated with a person, and a small ratio of colors associated with the baseball field ground. Accordingly, the close-up scene may be detected by using such features.

As another example, when the online model is an audio model of the announcer's tone of voice, it may be determined whether audio data meets the announcer's tone of voice by using the online model.

In operation S280, the online model may be updated, since the detected event data may be a sample meeting the online model standard. In this instance, the online model may be updated by using a weighted average value of a current online model and a detected event sample. Further, the online model may be updated by using a median value of the current online model and the detected event sample. Still further, the online model may be updated by using a Gaussian mixture of the current online model and the detected event sample, noting that alternative embodiments are equally available

As another example, in operation S280, when the online model is a key frame model of a pitching scene, an average value may be updated by using the edge distribution and the HSV histogram of a newly detected key frame of the pitching scene, and the updated average value may be used in a new online model.

As another example, in operation S280, when the online model is a color model of the baseball ground, and when a scene is not determined to be a close-up scene, cells in the color model of the baseball ground may be reflected. In this instance, the cells are similar to the online model. In addition, the HSV average value again may be calculated again, and the online model may again be updated.

As another example, in operation S280, when the online model is an audio model of the announcer's tone of voice, the average energy value may be updated by using energy values of each audio frame.

As described above, when the confidence of the online model is high, the method of detecting an event, according to an embodiment of the present invention, may detect events by using the online model, and may further update the online model based on the detected events.

In operation S290, whether a point in which operations of the detecting of the event, by using the online model, or the updating the online model, are to cease are determined by whether the sports video stream indicates that it is the end of the sports video stream.

When the end point has not been reached, operations from operation S210 may be repeated.

In operation S260 or S290, when the cessation point for detecting the event by using the online model and/or the offline model is met, operations of detecting events according to an embodiment of the present invention may, thus, be terminated.

Thus, in view of the above, a method of detecting an event in sports video data, according to an embodiment of the present invention, may combine an online training model and an offline training model. When a recording of the sports video starts, the online model training begins, while event detection is being performed by the offline training model. When a confidence of the online training model is sufficiently high, the detecting of events in the sports video may then be switched and events may be detected by applying the online training model.

In addition, with the above, events may be detected in real time, while a sports game progresses. Accordingly, users may watch the sports game using a time shift function for each event. Thus, such detecting of events in sports videos may similarly be applied to any type of device in which a video summary function is installed.

Further, according to an embodiment, an adaptive online model for each sports game may be generated, and the generated online model may be continuously adapted, thereby increasing event detection accuracy. For example, in a pitching scene, in one embodiment, such a method of detecting an event in the sports video data shows a performance of P1:0.988 over fifteen baseball game videos, while a conventional method of detecting an event shows a performance of only P1:0.957 over five baseball game videos.

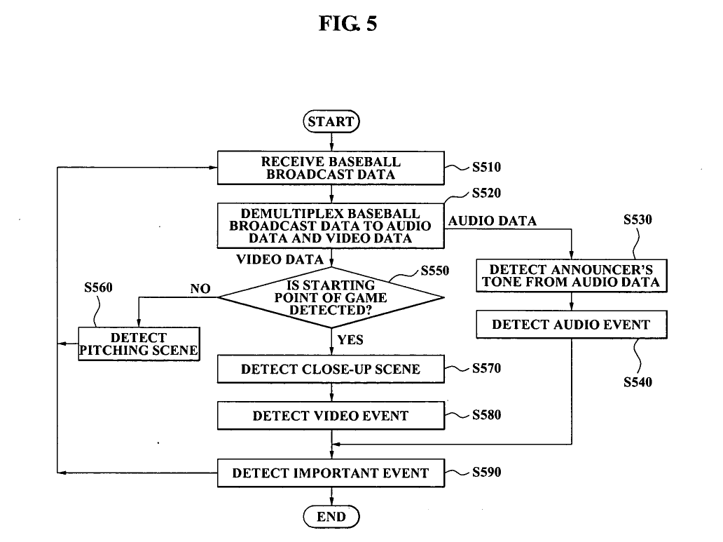

FIG. 5 illustrates a method of detecting an important event in baseball video data, according to an embodiment of the present invention.

Referring to FIG. 5, in operation S510, baseball broadcast data may be received through a broadcast receiver, for example.

In operation S520, the baseball broadcast data may be demultiplexed into audio data and video data, e.g., such as through a demultiplexer (DEMUX).

In operation S530, when the demultiplexed baseball broadcast data is the audio data, an announcer's tone of voice may be detected from the audio data.

In operation S540, an audio event may be detected based on the detected announcer's tone of voice. Here, an audio event may be detected based on the detected announcer's tone of voice because the announcer's tone of voice may be generally high on homeruns or strikeouts, for example.

In operation S550, when the demultiplexed baseball broadcast data is the video data, it may be determined whether the received video data represents the starting point of a game. Here, the beginning of individual plays within the game may similarly be detected. As noted previously, in baseball games, events or plays typically start with pitching scenes and end with close-up scenes, similar to the scenes shown in FIG. 6.

In operation S560, when a starting point has not already been detected, the pitching scene may be detected in the video data. After the detecting of the pitching scene, operations from operation S510 may be repeated.

In operation S570, when the starting point has already been detected, a close-up scene from the video data may be detected for.

In operation S580, within the period between the pitching scene and the close-up scene, it may be determined whether a video event has occurred in the video data.

In operation S590, further, regarding the detection of the video event, it may be determined whether that event is an important event based upon the detected audio event and/or the detected video event. Specifically, in operation S590, an important event may be detected based upon the audio event, detecting by the announcer's tone of voice, and the video event, detected between the pitching scene and the close-up scene.

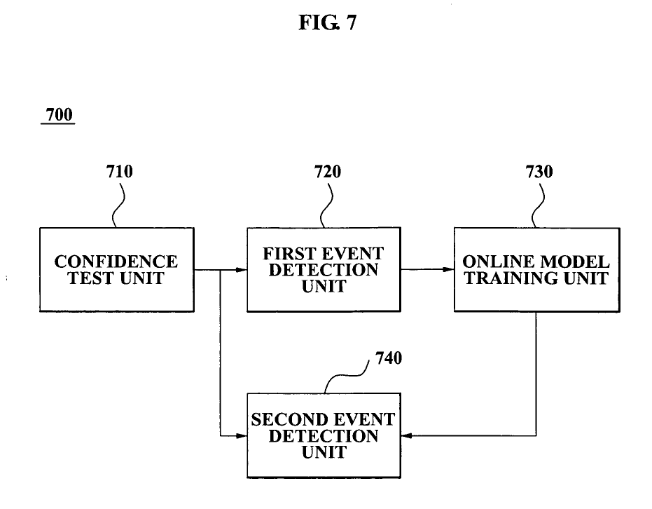

FIG. 7 illustrates an apparatus for detecting a real time event in sports video data, according to an embodiment of the present invention.

Referring to FIG. 7, the apparatus for detecting a real time event 700 may include a confidence test unit 710, a first event detection unit 720, an online model training unit 730, and a second event detection unit 740, for example.

The confidence test unit 710 may test a confidence for an online model, as calculated based on a sports video stream. Specifically, the confidence test unit 710 may calculate the confidence for the online model, as calculated based on the sports video stream, compare the calculated confidence for the online model with a threshold, and test the confidence for the online model.

The first event detection unit 720 may detect the event by using an offline model for the sports video stream, when the confidence for the online model is lower than the threshold.

The online model training unit 730 may further train the online model based on the event detected by the offline model.

When the event detected by using the offline model is video data, the online model training unit 730 may segment the video data into minimum units, e.g., frames or pixels, assign or generate clusters by analyzing the segmented minimum units, selects a cluster, that may be used to generate the implemented model, from the clusters and generates/updates the online model based upon detected events.

When the offline model detected event is audio data, the online model training unit 730 may calculate an audio energy value of the audio data, calculate an average energy by using a formerly calculated audio energy value and the currently calculated audio energy value, extract a recording level, and update the online model by using the extracted recording level.

Accordingly, the confidence of the online model can be improved by the updating of the online model after the training of the online model through the online model training unit 730.

Once the confidence of the online model is sufficiently high, e.g., greater than the threshold, the second event detection unit 740 may be used for detecting events based on the online model for the sports video stream.

As described above, in an embodiment of the present invention, an apparatus for detecting a real time event may detect events in real time.

In addition to the above described embodiments, embodiments of the present invention can also be implemented through computer readable code/instructions in/on a medium, e.g., a computer readable medium, to control at least one processing element to implement any above described embodiment. The medium can correspond to any medium/media permitting the storing and/or transmission of the computer readable code.

The computer readable code can be recorded/transferred on a medium in a variety of ways, with examples of the medium including magnetic storage media (e.g., ROM, floppy disks, hard disks, etc.), optical recording media (e.g., CD-ROMs, or DVDs), and storage/transmission media such as carrier waves, as well as through the Internet, for example. Here, the medium may further be a signal, such as a resultant signal or bitstream, according to embodiments of the present invention. The media may also be a distributed network, so that the computer readable code is stored/transferred and executed in a distributed fashion. Still further, as only an example, the processing element could include a processor or a computer processor, and processing elements may be distributed and/or included in a single device.

Accordingly, advantages of an embodiment of the present invention include providing a method, medium, and apparatus detecting an event in real time in sports video data according to at least the above-described embodiments, which combines an offline training model and an online training model.

Further advantages of an embodiment of the present invention include providing method, medium, and apparatus detecting an event in real time in sports video data by detecting an event using an offline model prior to implementing an online model.

Still further, advantages of an embodiment of the present invention include providing a method, medium, and apparatus detecting an event in real time in sports video data by generating an online model for any game in the sports video, and adaptively updating the generated online model.

Advantages of an embodiment of the present invention include providing a method, medium, and apparatus detecting an event in real time in sports video data using previous received data by way of training and detected information in real time without having to use information of the entire stream when generating an online model, which may thereby improve processing speed.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. A method of detecting an event, the method comprising:
determining a confidence value of an online model for detecting an event in an input data stream;
detecting an event by using an offline model for detecting the event in the input data stream when the confidence value of the online model is lower than a threshold; and
detecting the event by using an online model for the input data stream when the confidence value of the online model is higher than the threshold.

2. The method of claim 1, wherein the input data stream is a sports video stream.

3. The method of claim 1, further comprising training the online model through the detected event such that a confidence level of the online model is increased for the detected event at least when the detected event is detected by the offline model.

4. The method of claim 3, wherein the training of the online model comprises training the online model through the detected event when the detected event detected by the offline model satisfies a standard for the online model.

5. The method of claim 1, further comprising updating the online model after detecting the event by using the online model.

6. The method of claim 3, wherein the training of the online model further comprises:
segmenting video data of the detected event into frames according to minimum units when the detected event detected by the offline model is the video data;
selectively assigning and generating clusters for the online model by analyzing the minimum units; and
selecting a cluster for generating a to be implemented model, from the selectively assigned and generated clusters, and generating the online model with at least the selected cluster.

7. The method of claim 6, wherein the selectively assigning and the generating comprises:
calculating a difference value between at least one preexisting cluster and a newly calculated cluster based upon the detected event;
assigning data of the newly calculated cluster to the at least one preexisting cluster when the difference value meets a difference threshold; and
generating at least one new cluster for the data of the newly calculated cluster at least when the difference value does not meet the difference threshold or no preexisting cluster exists.

8. The method of claim 3, wherein the training comprises:
calculating an audio energy value of an audio frame, when the detected event detected by the offline model is the audio frame;
calculating an average energy by using a preexisting calculated audio energy value and the calculated audio energy value for the detected event, and extracting a corresponding recording level; and
updating the online model with the extracted recording level.

9. At least one medium comprising computer readable code to control at least one processing element to implement the method of claim 1.

10. At least one medium comprising computer readable code to control at least one processing element to implement the method of claim 3.

11. An apparatus for detecting a real time event comprising:
a confidence calculation unit to calculate a confidence value of an online model;
a first event detection unit to detect an event using an offline model when the confidence value of the online model does not meet a threshold; and
a second event detection unit to detect the event using the online model when the confidence value of the trained online model meets the threshold.

12. The apparatus of claim 11, wherein the confidence calculation unit calculates the confidence value of the online model in a sports video stream, compares the calculated confidence of the online model and the threshold, and determines a corresponding confidence level of the online model.

13. The apparatus of claim 11, further comprising an online model training unit to train the online model through the detected event such that a confidence level of the online model is increased for the detected event at least when the detected event is detected by the offline model.

14. The apparatus of claim 13, wherein the online model training unit, when the detected event detected by the offline model is video data, segments the video data of the detected event into frames according to a minimum unit, selectively assigns and generates clusters for the online model by analyzing the segmented frames, selects a cluster for generating a to be implemented model from the selectively assigned and generated clusters, and generates the online model with at least the selected cluster.

15. The apparatus of claim 13, wherein the online model training unit, when the detected event detected by the offline model is an audio frame, calculates an audio energy value of the audio frame, calculates an average energy of a preexisting calculated audio energy value and a currently calculated audio energy value for the detected event, extracts a corresponding recording level, and updates the online model with the extracted recording level.
